(19) United States
(12) Patent Application Publication
(10) Pub. No.: US 2009/0026655 A1
(43) Pub. Date: Jan. 29, 2009

(54) FORMING METHOD FOR FIBER REINFORCED RESIN

(75) Inventor: Kuo-Pin YU, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Yuan Min An Enterprise Co., Ltd., Taichung (TW)

(21) Appl. No.: 11/828,109

(22) Filed: Jul. 25, 2007

(51) Int. Cl. B29C 70/46

(52) U.S. Cl. 264/258

(57) ABSTRACT

A forming method for fiber reinforced resin includes the following steps. First, put a stack of pre-pregs into a cavity of a die having a plurality of openings in communication with the cavity and the space outside the die. Then heat the die and exhaust air through the openings from the cavity of the die. Thus, the air bubbles between the pre-pregs as well as surplus resin can be drawn out such that the product has improved mechanical strength.

### BACKGROUND OF THE INVENTION

1. Field of the Invention

The present invention relates to fiber reinforced resin and more particularly, to a forming method for fiber reinforced resin, which can remove air bubbles inside the fiber reinforced resin effectively such that the product has improved mechanical strength.

2. Description of the Related Art

As shown in FIG. 1, a conventional forming method for fiber reinforced resin is to roll a stack of pre-pregs into a tube 1, then put the tube 1 into a cavity 3 of a die 2. The die 2 consists of an upper die 4 and a lower die 5 between which an annular resin groove 6 surrounding the cavity 3 is defined. Heat the die 2 with two heating board 7 and pump high pressure air into an envelope 91 inside the tube 1 such that the tube 1 is inflated to stop against the periphery of the cavity 3. The tube 1 is then cured after a period of time.

In accordance with technology level nowadays, it is not possible to avoid the generation of the air bubbles 8 between pre-pregs while stacking the pre-pregs. The mechanical strength of the product is reduced due to these structural defects, i.e. the air bubbles 8. One solution to improve this situation is to exhaust air outside the heated die 2. The air bubbles 8 between the pre-pregs are drawn out when the resin is heated and melts. But the effect is only obvious at a part of the pre-pregs near the gap 9 between the upper die 4 and the lower die 5. The air bubbles 8 in the other part of the pre-pregs are still very hard to be drawn out. Another solution is to exhaust air from the resin groove 6 to draw out the air bubbles 8. It has a better effect than the aforesaid one, but the influenced area of the pre-pregs is still limited to the position near the gap 9. The number of the air bubbles 8, i.e. structural defects, in the product formed by this way is still large such that the mechanical strength is poor.

### SUMMARY OF THE INVENTION

The present invention has been accomplished under the circumstances in view. It is one object of the present invention to provide a forming method for fiber reinforced resin, which can remove air bubbles inside the fiber reinforced resin effectively.

It is another object of the present invention to provide a forming method for fiber reinforced resin, the product of which has improved mechanical strength.

To achieve these and other objects of the present invention, the forming method for fiber reinforced resin includes the following steps. First, put a stack of pre-pregs into a cavity of a die having a plurality of openings in communication with the cavity and the space outside the die. Then heat the die and exhaust air through the openings from the cavity of the die. Thus, the air bubbles between the pre-pregs as well as surplus resin can be drawn out such that the product has improved mechanical strength.

### BRIEF DESCRIPTION OF THE DRAWINGS

FIG. 1 is a schematic view of the conventional forming method for fiber reinforced resin.

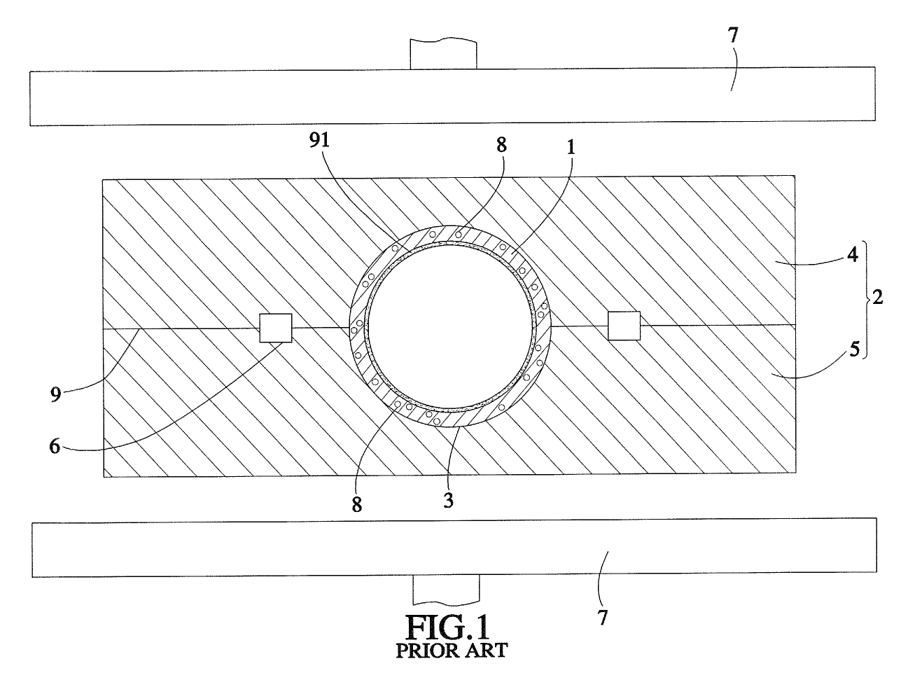

FIG. 2 is a perspective view of a die adopted by a first embodiment of the present invention.

FIG. 3 is a schematic view of the first embodiment of the present invention.

FIG. 4 is a schematic view of a second embodiment of the present invention.

FIG. 5 is a schematic view of a third embodiment of the present invention.

### DETAILED DESCRIPTION OF THE INVENTION

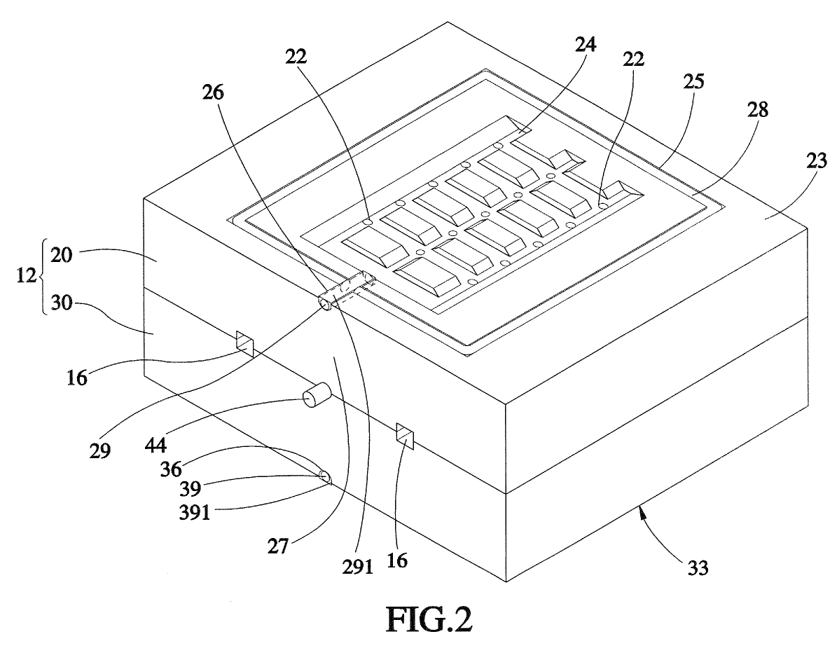

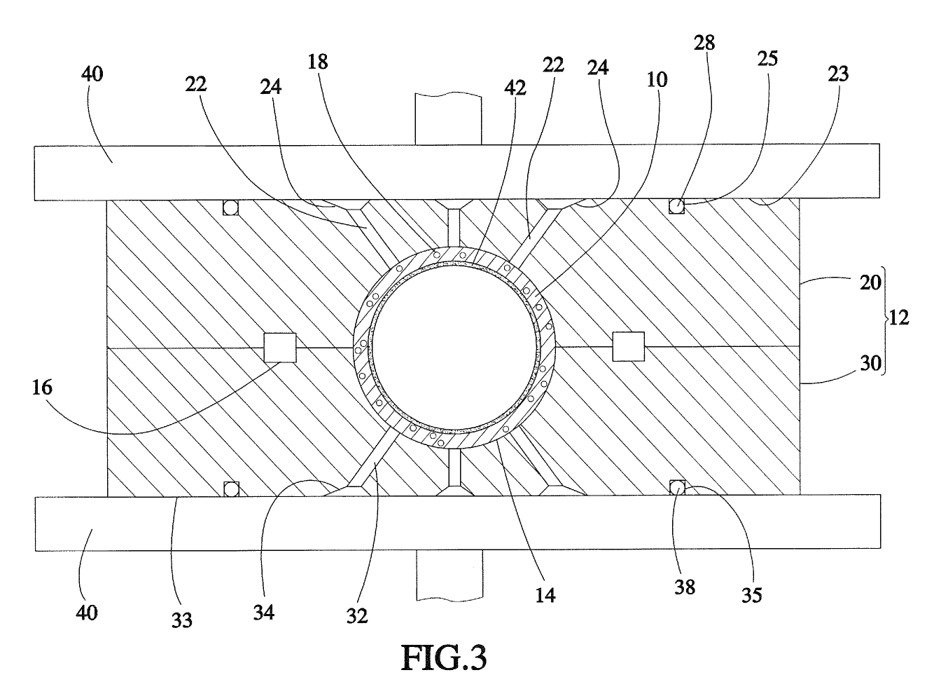

Referring to FIGS. 2-3, a forming method for fiber reinforced resin in accordance with the first embodiment of the present invention comprises the following steps. First, roll a stack of pre-pregs into a tube 10 and then put the tube 10 into a cavity 14 of a die 12. The fiber of the pre-pregs can adopt but not limit to carbon fiber, glass fiber, boron fiber or Kevlar fiber. The resin of the pre-pregs can adopt thermosetting resin or thermoplastic resin. The die 12 consists of an upper die 20 and a lower die 30. An annular groove 16 surrounding said cavity 14 is defined between the upper die 20 and the lower die 30.

The upper die 20 is provided with a plurality of opening 22 in communication with the cavity 14 and the space outside the die 12. A top surface 23 of the upper die 20 is provided with a trough 24, an annular channel 25 surrounding said trough 24, and a receiving trench 26 extending from said trough 24 to a side surface 27 of the upper die 20. The openings 22 are located within the trough 24. A seal 28 made of flexible material, such as silicone and rubber, is received in the annular channel 25. An air valve 29 with a sheath 291 is received in the receiving trench 26. The sheath 291 is also made of flexible material such as silicone or rubber such that the air valve 29 is well airtight.

Similarly, the lower die 30 has a plurality of openings 32, a trough 34 located at the bottom surface 33, an annular channel 35, a receiving trench 36, a seal 38 and an air valve 39 with a sheath 391.

Then, two heating boards 40 are respectively stopped against the top surface 23 of the upper die 20 and the bottom surface 33 of the lower die 30. On the one hand, the heating boards 40 heat the die 12; on the other hand, the heating boards 40 press on the seals 28, 38 and the sheath 291, 391 of the air valve 29, 39 such that the trough 24 of the upper die 20 and the trough 34 of the lower die 30 are well airtight. At the same time, an air pump (not shown) exhausts air through the air valve 29, 39, the trough 24, 34 and the openings 22, 32 from the cavity 14 of the die 12. High pressure gas is pumped into an envelope 42 inside the tube 10 via an air valve 44 such that the tube 10 is inflated to stop against the periphery of the cavity 14. Since the resin of the pre-pregs is melt by the heat of the die 12, the air bubbles 18 between the pre-pregs can be drawn out via the openings 22, 32. Besides, the air around the die 12 and the air inside the annular groove 16 can also be exhausted such that the air bubbles 18 between the pre-pregs can be drawn out through the gap between the upper die 20 and the lower die 30. The pre-pregs is then cured after a predetermined period of time. Thus, there are no or few air bubbles in the product formed by the method of the present invention such that the structural strength of the product is excellent. Furthermore, surplus resin can be drawn out via the gap between the upper die 20 and the lower die 30 and stay in the annular groove 16. Or the surplus resin can be drawn out via the opening 22, 32 and stay in the trough 24, 34. By either way, the wall thickness of the product is more even than the one formed by conventional method; hence the mechanical strength of the product of the present invention is also more uniform.

The forming method of the present invention can apply to various product made by fiber reinforced material, especially those product having a large surface area, such as airplane parts, motor vehicle parts, sports goods, baggage parts, computer parts, bicycle parts, etc. The products of the forming method of the present invention have improved mechanical strength and lighter weight than conventional ones.

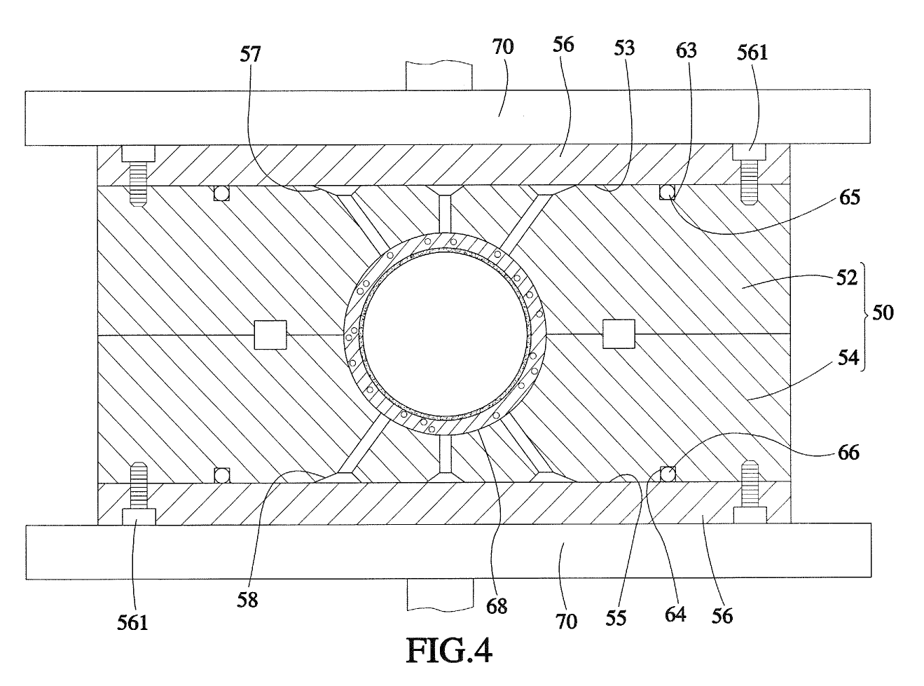

In this embodiment, the surplus resin drawn out via the opening 22, 32 stay in the troughs 24, 34, which are removed after the forming process is over. But the resin often adheres to the heating boards 40, which is very difficult to remove. Therefore the structure of the die can be changed as shown in FIG. 4, in which the die 50 adopted by the second preferred embodiment of the present invention is shown. The die 50 is the same with the one provided in the first embodiment but two boards 56 are respectively mounted on the top surface 53 of the upper die 52 and the bottom surface 55 of the lower die 54 by several screw bolt 561. The trough 57 and the receiving trench (not shown) of the upper die 52, and the trough 58 and the receiving trench (not shown) of the lower die 54 are all covered by the boards 56 such that the troughs 57, 58 communicates with the space outside the die 50 only through two air valve (not shown). Two seal 65, 66 are respectively received in the annular channel 63 of the upper die 52 and the annular channel 64 of the lower die 54 and stop against the boards 56. Thus, an air pump (not shown) exhausts air, as well as surplus resin, through the air valves from the cavity 68. Two heating boards 70 heat the die 50 via the boards 56 such that the resin is avoided adhering to the heating boards 70. The resin in the trough 57, 58 or on the boards 56 is removed after the boards 56 is disassemble from the die 50. Removing of the resin is convenience since the boards 56 are taken away from the die 50 easily.

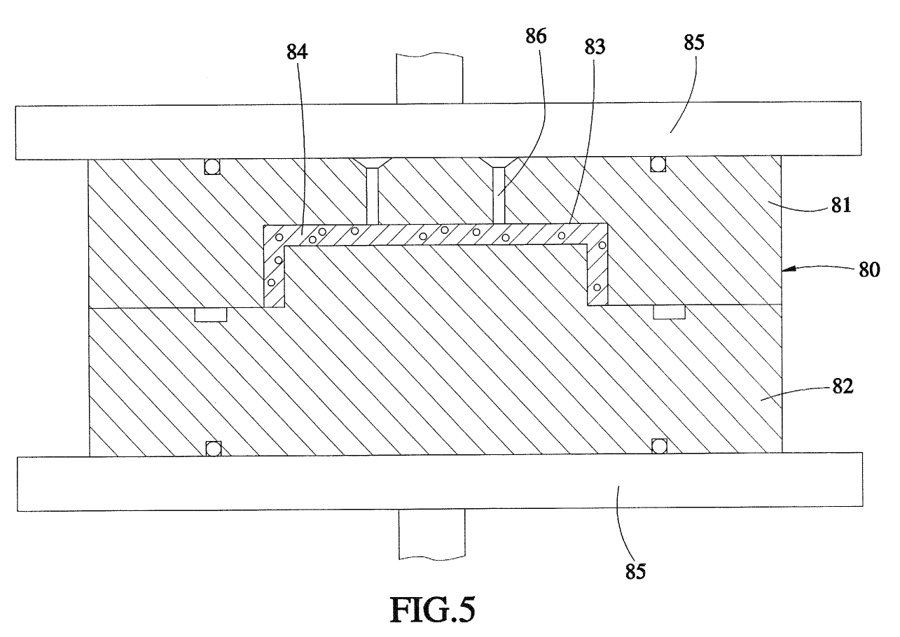

The method adopted by aforesaid two embodiments is so-called inner pressure method. The spirit of the present invention can be applied to outer pressure method. As shown in FIG. 5, the die 80 adopted by the forming method in accordance with the third embodiment of the present invention comprises an upper die 81, a lower die 82 and a cavity 83 defined between the upper die 81 and the lower die 82. The upper die 81 is provided with two openings 86. The method comprises the steps of putting several pre-pregs layer by layer into a sheet 84, and then putting the sheet 84 into the cavity 83, and then heating the die 80 with the two heating boards 85 and exhausting air through the openings 86. There is no need to pump high pressure air into the envelope inside the tube as the inner pressure method. In this embodiment, exhausting air through the openings 86 of the upper die 81 is efficient enough to draw out the air bubbles in the sheet 84 since the sheet 84 is relatively thin. The lower die 82 may be provided with several openings under the situation the sheet is relatively thick.

It is worth to mention that the inner pressure method and the outer pressure method can be adopted within one die, for example, the die for a hockey stick. The handle of the hockey stick is formed by inner pressure method and the bottom blade is form by outer pressure method. The die is also provided with openings for exhausting air.

Base on the spirit of the present invention, the die provided with at least one opening for exhausting air is enough to implement the method of the present invention. It is still fallen within the scope of the present invention no matter how many parts the die is divided, how and what the quantity and the position of the openings is changed, whether the trough, annular channel or the receiving trench is provided or not, or in what way the die is heated. Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A forming method for fiber reinforced resin comprises the steps of:
(a) putting a stack of pre-pregs into a cavity of a die having at least one opening in communication with said cavity and the space outside said die; and
(b) heating said die and exhausting air through said opening from said cavity of said die.

2. The forming method as claimed in claim 1, wherein an outer surface of said die is provided with a trough in which said opening is located.

3. The forming method as claimed in claim 2, wherein said outer surface of said die is provided with an annular channel surrounding said trough for receiving a seal.

4. The forming method as claimed in claim 2, wherein said die is provided with a receiving trench extending from said trough for receiving an air valve.

5. The forming method as claimed in claim 4, wherein said outer surface of said die is provided with an annular channel surrounding said trough for receiving a seal.

6. The forming method as claimed in claim 4, wherein said trough and said receiving trench of said die are covered with a board such that said trough communicates with the space outside said die through said air valve.

7. The forming method as claimed in claim 6, wherein said outer surface of said die is provided with an annular channel surrounding said trough for receiving a seal.

8. The forming method as claimed in claim 1, wherein said pre-pregs are rolled into a tube in step (a) and high pressure gas is pumped into said tube in step (b).
